(19) United States
(12) Patent Application Publication
(10) Pub. No.: US 2010/0257112 A1
(43) Pub. Date: Oct. 7, 2010

(54) SOCIALIZATION OF COMMUNICATIONS ENABLED DEVICES

(75) Inventors: Karen L. Barrett, Chatswood (AU); Verna L. Iles, North Parramatta (AU); Muneyb Minhazuddin, Quakers Hill (AU); Daniel Yazbek, Five Dock (AU)

Correspondence Address: SHERIDAN ROSS P.C., 1560 BROADWAY, SUITE 1200, DENVER, CO, 80202, US

(73) Assignee: Avaya Inc., Basking Ridge, NJ (US)

(21) Appl. No.: 12/416,701

(22) Filed: Apr. 1, 2009

(51) Int. Cl. G06Q 10/00

(52) U.S. Cl. 705/319

(57) ABSTRACT

The present invention provides a systems, device, and methods for establishing an ad-hoc communication network. Members to the ad-hoc network are allowed to operate in a social mode that allows the devices to share state information with one another and further implement similar behavioral mannerisms. More specifically, the ad-hoc network may be defined by certain functions that are enabled/disabled and any member to that particular ad-hoc network agrees to operate its functionality according to the functions that have been enabled/disabled for that network.

### FIELD OF THE INVENTION

The invention relates generally to communication systems and more particularly to the ad-hoc establishment of social communication networks.

### BACKGROUND

The use of mobile or personal communication devices, such as laptops, cellular phones, mobile email retrieval devices, personal digital assistants (PDAs), smart phones, etc. has increased dramatically in recent years. It is not uncommon for individuals to carry more than one personal communication device or for every member of a family to carry their own personal communication device. The popularity of such devices has increased due to advances in communication networks supporting such devices and the features offered by such devices. For instance, a person can now surf the Internet, make a call, Instant Message (IM) with multiple friends, listen to music, download songs, text, and maintain their calendar all with a single communication device. While this does make communication device users happy due to the fact that they can carry fewer devices and still have access to all of their favorite applications, it has not come without negative impact.

For example, most movie theaters now have a dedicated message played prior to the beginning of a movie that reminds all patrons to turn their cell phones off or at least put them in silent mode (e.g., disable audible notifications). Ten years ago this was not a problem. While the reminder message does help remind those who are present and paying attention to the reminder to change the behavior of their phone, it does not help latecomers or other individuals who are not paying attention to the previews. If these patrons fail to turn their cell phone off, someone may call them during the movie, thereby interrupting the movie for all other patrons. This has become socially unacceptable.

As another example, most college students bring their laptops to a lecture not as a note-taking device, but as a tool to IM their class mates (i.e., pass electronic notes), pay the bills during class, surf the Internet, or find some other distraction. This has led to many complaints by professors and lecturers alike.

As yet another example, some companies have instituted “lap-topless” meetings. In these meetings, the participants are not allowed to bring their laptops or any other communication device that would lead to distractions during the meeting. In addition to being found rude, the use of laptops and other communication devices during meetings leads to partial attention from many or all participants, which may lead to less-than-desirable results. The problems remains that it may be necessary during some meetings to have a laptop available and movie theaters are not anywhere near instituting a “no cell phone policy.”

### SUMMARY

Accordingly, there exists a need for control mechanisms that allow communication device-carrying individuals to have their communication devices be temporarily controlled in accordance with socially acceptable norms. More specifically, there exists a need to allow communication devices to socialize with one another, without necessarily utilizing the general service provider's communication network, and mimic each others' behaviors.

These and other needs are addressed by various embodiments and configurations of the present invention. It is thus one aspect of the present invention to provide a method that generally comprises:

receiving, at a communication device, an invitation to join a social network comprising a communication device behavior associated therewith;

receiving an indication to accept the invitation to subscribe to the social network; and

altering a behavior of the communication device from a first default behavior to a second behavior, wherein the second behavior complies with the communication device behavior associated with the social network.

The invitation to join the social network may be received from an existing member of the social network. This existing member may be in an operating mode whereby it searches for communication devices within proximity therewith (e.g., within wireless communication range). As an example, the communication range of a social network may be limited by the wireless communication range of a particular protocol (e.g., Bluetooth, IEEE 802.11 (Wi-Fi), Zigbee, Near Field Communications (NFC), etc.) employed by communication devices. As long as a communication device is within such a range of at least one other subscriber to the social network (or within range of a controlling subscriber), that communication device may be allowed to subscribe to the social network and share the behaviors defined for that network.

As can be appreciated, the invitation does not necessarily need to come from an existing member, but instead may come from a social network facilitator, whose dedicated purpose is to enroll other communication devices into the social network. The range of the social network in this case may be limited by the wireless communication range of the social network facilitator.

It is thus one aspect of the present invention to provide a network independent solution for connecting communication devices in close physical proximity to one another and allowing such communication devices to establish an ad-hoc social network with one another. Once a part of the ad-hoc social network, the communication devices can subscribe to socially acceptable behaviors associated with that social network, thereby causing the subscribing communication device to mimic the behavior of other communication devices belonging to the social network.

It is another aspect of the present invention to allow communication devices to socialize with one another over long distances, possibly utilizing a service provider's communication network to share social information between social network subscribers. Thus, a social network having socially acceptable behaviors defined in connection therewith can be established between devices across the globe.

It is one aspect of the present invention to provide an operating mode for communication devices whereby they are allowed to socialize with other communication devices operating in the same “social mode.” Once in this mode, the devices are allowed to share certain state information with one another via a communication channel. This allows a person to, for example, in a movie theatre or meeting have their phone notice other phones are on “silent” and is ‘socialized’ to act accordingly. In another example, during an emergency, after a phone has identified that nearby devices are calling 000 (911 if you are in the US) the phone attempts to make the same emergency call in case its carrier has better reception. This could also be good in identifying witnesses (e.g., based on knowing that communication devices that were present at a crime scene because they were a part of a social group around that location and this information was stored in a community log of another phone) and for providing better information to the services on locations and potential resources already present at the scene (is there a doctor in the house?) (e.g., because a user's profession or other social networking information could be shared with other devices that have joined the community).

Embodiments of the present invention may prove particularly useful in business settings where meetings are conducted with laptops and the presenter asks that all other devices socialize with the presenter's device. This may allow the presenter to temporarily disable the other communication devices from surfing the web or allow them to all automatically go to the same website without requiring user input. This would also be useful in classroom settings when teachers are annoyed by their students sending IM messages to one another. If the students were required to socialize their laptops with the teacher's, the teacher may be able to temporarily control whether the students are allowed to send IM messages.

A social network may be created in an ad-hoc fashion by allowing the communication devices operating in the social mode to discover one another through a query and response type protocol. Each communication device may maintain a table of other discovered communication devices and may send social data to only those communication devices. Alternatively, the table may be maintained by a common device that supports socialization of the communication devices (e.g., a wireless router that is providing wireless internet connections to a group of laptops in a conference room) and that common device may facilitate the transmission of social data among the group.

One concern raised is that people may attempt to maliciously control other person's communication devices when they are socializing. These attacks could be avoided by having each user define what social reactions are acceptable for their device and further define what types of social data it is allowed to share with the social network. Additionally, the user may be prompted before the device tries to execute a social behavior (e.g., “do you want to echo X social behavior?”).

Another alternative that may be possible under the present invention is the ability to automatically change the behavior of the device based on the existing device community. For example, different socializing rule sets or behaviors may be used for a device depending upon the number of devices in the community and/or the type of devices in the community.

As used herein “behaviors” or alteration of a behavior is meant to include engagement/disengagement of communication device functions, engagement/disengagement of communication device applications, engagement/disengagement of communication device components (e.g., speaker, lights, screen, vibrating components, etc.), and combinations thereof. Accordingly, when a communication device subscribes to a social network and agrees to alter its behavior in accordance therewith, the communication device may have one or more of its functions, applications, and components behave similarly to other communication devices in the social network. If the subscribing communication device does not have a particular function, application, or component defined in a social network's behavior, then that communication device simply ignores that aspect of the social network's behavior while complying with any other behavior that can be supported by the communication device.

The use of Bluetooth communications between associated communication devices has been known. However, Bluetooth is typically used to allow one communication device to act through another communication device (i.e., both communication devices are associated with the same user and same application). The present invention, on the other hand, allows for the socialization of different communication devices associated with different users. Furthermore, the behaviors shared between communication devices may include deactivating certain applications, such as any Bluetooth enabled applications, while the communication devices subscribe to the social network.

The term “automatic” and variations thereof, as used herein, refers to any process or operation done without material human input when the process or operation is performed. However, a process or operation can be automatic even if performance of the process or operation uses human input, whether material or immaterial, received before performance of the process or operation. Human input is deemed to be material if such input influences how the process or operation will be performed. Human input that consents to the performance of the process or operation is not deemed to be “material”.

The term “computer-readable medium” as used herein refers to any tangible storage and/or transmission medium that participates in providing instructions to a processor for execution. Such a medium may take many forms, including but not limited to, non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, RAM, PROM, EPROM, FLASH-EPROM, solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable media is configured as a database, it is to be understood that the database may be any type of database, such as relational, hierarchical, object-oriented, and/or the like. Accordingly, the invention is considered to include a tangible storage medium or distribution medium and prior art-recognized equivalents and successor media, in which the software implementations of the present invention are stored.

The terms “determine,” “calculate” and “compute,” and variations thereof, as used herein, are used interchangeably and include any type of methodology, process, mathematical operation or technique.

The term “module” as used herein refers to any known or later developed hardware, software, firmware, artificial intelligence, fuzzy logic, or combination of hardware and software that is capable of performing the functionality associated with that element. Also, while the invention is described in terms of exemplary embodiments, it should be appreciated that individual aspects of the invention can be separately claimed.

The preceding is a simplified summary of the invention to provide an understanding of some aspects of the invention. This summary is neither an extensive nor exhaustive overview of the invention and its various embodiments. It is intended neither to identify key or critical elements of the invention nor to delineate the scope of the invention but to present selected concepts of the invention in a simplified form as an introduction to the more detailed description presented below. As will be appreciated, other embodiments of the invention are possible utilizing, alone or in combination, one or more of the features set forth above or described in detail below.

### BRIEF DESCRIPTION OF THE DRAWINGS

FIG. 1 is a block diagram depicting a communication system in accordance with at least some embodiments of the present invention;

FIG. 2 is a block diagram depicting a communication system including a first configuration of a social network in accordance with at least some embodiments of the present invention;

FIG. 3 is a block diagram depicting a communication system including a second configuration of a social network in accordance with at least some embodiments of the present invention;

FIG. 4 is a block diagram depicting a first data structure employed in accordance with at least some embodiments of the present invention;

FIG. 5 is a block diagram depicting a second data structure employed in accordance with at least some embodiments of the present invention;

FIG. 6 is a flow diagram depicting a social network discovery method in accordance with at least some embodiments of the present invention;

FIG. 7 is a flow diagram depicting a social network admission method in accordance with at least some embodiments of the present invention; and

FIG. 8 is a flow diagram depicting a method of facilitating a mandatory compliance social network in accordance with at least some embodiments of the present invention.

### DETAILED DESCRIPTION

The invention will be illustrated below in conjunction with an exemplary communication system. Although well suited for use with, e.g., a system using a server(s) and/or database(s), the invention is not limited to use with any particular type of communication system or configuration of system elements. Those skilled in the art will recognize that the disclosed techniques may be used in any communication application in which it is desirable to allow communications enabled devices to socialize and share behavioral characteristics.

The exemplary systems and methods of this invention will also be described in relation to communications software, modules, and associated communication hardware. However, to avoid unnecessarily obscuring the present invention, the following description omits well-known structures, network components and devices that may be shown in block diagram form, are well known, or are otherwise summarized.

For purposes of explanation, numerous details are set forth in order to provide a thorough understanding of the present invention. It should be appreciated, however, that the present invention may be practiced in a variety of ways beyond the specific details set forth herein.

Furthermore, while the exemplary embodiments illustrated herein show the various components of the system collocated, it is to be appreciated that the various components of the system can be located at distant portions of a distributed network, such as a communication network and/or the Internet, or within a dedicated secure, unsecured and/or encrypted system. Thus, it should be appreciated that the components of the system can be combined into one or more devices, such as an enterprise server, a PBX, or collocated on a particular node of a distributed network, such as an analog and/or digital communication network. As will be appreciated from the following description, and for reasons of computational efficiency, the components of the system can be arranged at any location within a distributed network without affecting the operation of the system. For example, the various components can be located in a local server, at one or more users' premises, or some combination thereof. Similarly, one or more functional portions of the system could be distributed between a server, gateway, PBX, and/or associated communication device.

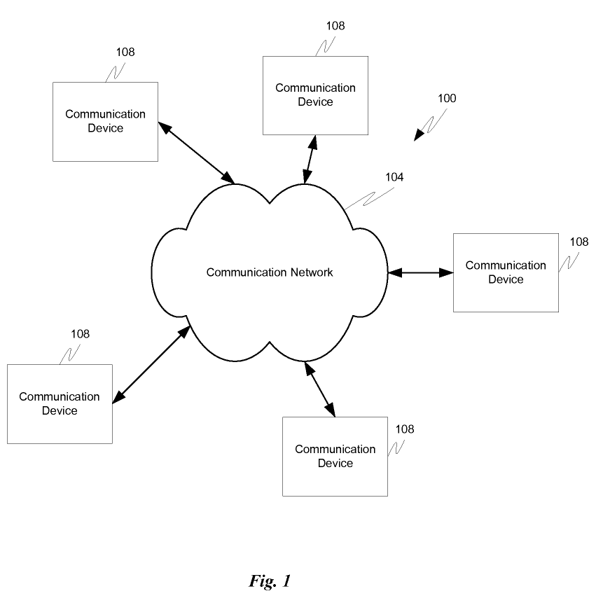

Referring initially to FIG. 1, an exemplary communication system 100 will be described in accordance with at least some embodiments of the present invention. In accordance with at least one embodiment of the present invention, a communication system 100 may comprise one or more communication devices 108 that may be in communication with one another via a communication network 104. The communication devices 108 may be any type of known communication or processing device such as a personal computer, laptop, tablet PC, Personal Digital Assistant (PDA), cellular phone, smart phone, telephone, digital camera, or combinations thereof. In general, each communication device 108 may be adapted to support video, audio, and/or data communications with other communication devices 108.

The communication network 104 may comprise any type of information transportation medium and may use any type of protocols to transport messages between endpoints. The communication network 104 may include wired and/or wireless communication technologies. The Internet is an example of the communication network 104 that constitutes an IP network consisting of many computers and other communication devices located all over the world, which are connected through many telephone systems and other means. Other examples of the communication network 104 include, without limitation, a standard Plain Old Telephone System (POTS), an Integrated Services Digital Network (ISDN), the Public Switched Telephone Network (PSTN), a Local Area Network (LAN), a Wide Area Network (WAN), a Session Initiation Protocol (SIP) network, and any other type of packet-switched or circuit-switched network known in the art. In addition, it can be appreciated that the communication network 104 need not be limited to any one network type, and instead may be comprised of a number of different networks and/or network types.

In accordance with at least some embodiments of the present invention, the communication devices 108 may comprise an operating system and a number of specific applications that execute specific functions within or on behalf of the communication device 108. The operating system of the communication device 108 is generally a high level application that enables a user to navigate and utilize the other applications stored on the communication device 108. The specific applications may include word processing applications, editing applications, spreadsheet applications, communication applications (with various applications for various communication mediums), web browsing applications, and any other type of known or yet to be developed application.

Each communication device 108 may also be designed to support one or more specific features or functions. The types of features supported by a communication device 108 may depend upon the nature of the communication device 108, the age of the communication device 108, the types of applications included in the communication device 108 (i.e., a communication device 108 not equipped with an email or web-surfing application will likely not be able to support email functionality), and so on.

Moreover, each communication device 108 may further comprise various components that allow the user of the device to interact and employ the applications and/or functionality of the communication device 108. Such components of the communication device 108 may include, without limitation, a user input (buttons, pointing device, touch-screen, microphone, video camera, etc.), a user output (light(s), LEDs, known display screens (e.g., plasma, projection, LCD, and so on), speaker(s), etc.), a network interface (e.g., a wireless antenna, wireless modem, a wired modem, a communication port, a network driver, etc.), a processor or processing routine, and so on.

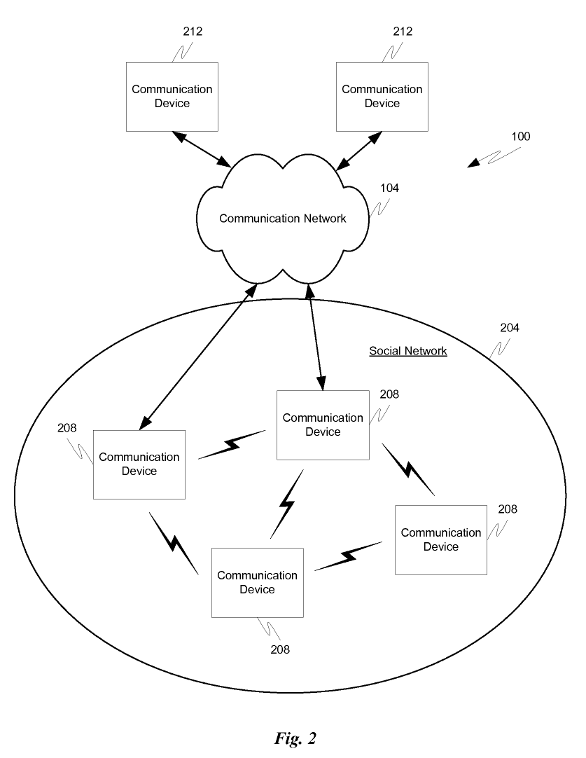

Referring now to FIG. 2, an exemplary configuration of a social network 204 will be described in accordance with at least some embodiments of the present invention. A first configuration of a social network 204 may include a number of subscribing communication devices 208, two or more of which are in communication with another subscribing communication device 208. In this distributed configuration the communication devices 208 belonging to the social network 204 are capable of communicating with and inviting other communication devices 108, typically via a search and locate protocol. Additionally, each of the subscribing communication devices 208 may receive and analyze requests from other communication devices 108 to join the social network 204. Other communication devices 108 can become a subscribing communication device 208 upon subscribing to the social network 204.

As can be seen in FIG. 2, the communications within the social network 204 may be carried out independent of the general communication network 104, which is generally operated by one or more service providers. Thus, the communication network 104 may comprise communication technologies, such as cellular communication technologies and IP-based communication technologies that allow for long-distance communication between communication devices 108, whereas the subscribing communication devices 208 utilize a short-distance wireless communication protocol to communicate with one another, separate of the communication network 104. For example, the subscribing communication devices 208 may utilize Bluetooth, Zigbee, NFC, Wi-Fi, or any other known or yet to be developed communication protocol to directly communicate with one another and bypass the communication network 104. The subscribing devices 208 may, however, still be enabled to communicate with non-subscribing communication devices 212 via the communication network 204, assuming the characteristics of the social network 204 permit such behavior.

In accordance with at least some embodiments of the present invention, each subscribing communication device 208 may comprise a table that lists other subscribing members, either by device identifier, user identifier, or combinations thereof. The subscriber table on a particular subscribing communication device 208 may include all other subscribing communication devices 208 in direct communication with that subscribing communication device 208. In an alternative embodiment, each subscribing communication device 208 may share table information with other members such that member information is shared among all subscribing communication devices 208. This allows for multiple instances of the member list to be maintained within the social network 204. Therefore, if one of the subscribing communication devices 208 leaves the range of the social network 204, the information relating to membership to the social network 204 is not lost.

In accordance with at least some embodiments of the present invention, the social network 204 may comprise a defined behavior that is to be implemented by any subscribing communication device 208. In other words, each subscribing communication device 208 may agree, due to their subscription to the social network 204, to implement behaviors defined for that social network 204. The behaviors defined for a particular social network 204 may be defined by a first communication device 208 that attempts to form the social network 204. For example, during creation of a social network 204, a user of a particular communication device 208 may define behaviors for the social network 204. When it sends an invitation to another communication device 208 to join the newly created social network 204, the newly defined behaviors associated with that social network 204 may be communicated to the invitee within the invitation. If the invitee accepts the invitation and agrees to join the social network 204, then the communication device 208 may then begin operating in accordance with the proper behavior defined for that social network 204.

Generally speaking, this socially acceptable behavior may remain static during the lifetime of the social network 204 (i.e., as long as there are at least two subscribing communication devices 208 to the social network 204). However, and in accordance with at least some embodiments of the present invention, the behaviors for that social network 204 may dynamically change during the life of the social network 204 provided that two or more communication devices 208 agree to the changes. If changes in the behavior for the social network 204 are changed, then all subscribing members (i.e., users of subscribing communication devices 208) may be asked if they agree to the changes. If all subscribers 208 agree, then the behavior of the social network 204 may be altered. If, however, two or more subscribers 208 don't agree to the change in behavior, then the social network 204 may be split into two different social network 204, whereby each social network 204 implements its respective behavior (i.e., the old social network 204 implements the previously defined behavior and the newly created social network 204 implements the newly defined behavior).

As can be appreciated by one skilled in the art, a communication device 208 may subscribe and belong to multiple social networks 204 at the same time. This condition may require that there are no conflicting behaviors between social networks 204 to allow the communication device 208 to operate in accordance with the behaviors associated with each social network 204. If there is a conflict between behaviors of a social network 204 (e.g., one behavior of a social network 204 requires disengagement of a component such as a speaker whereas another behavior of a social network 204 requires engagement of the same component), then the communication device 208 may only be allowed to subscribe to one of the social networks 204.

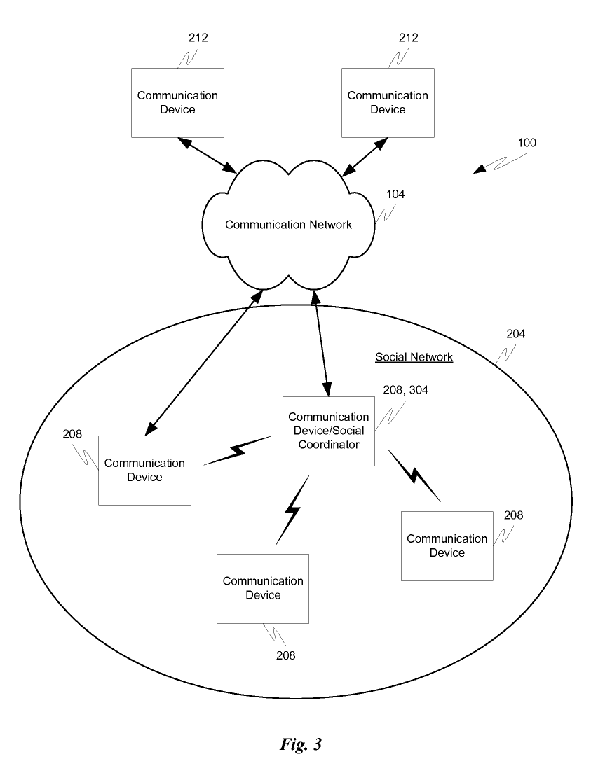

Referring now to FIG. 3, an alternative social network 204 configuration will be described in accordance with at least some embodiments of the present invention. The social network 204 may be controlled by a communication device/network facilitator 208, 304. This network facilitator 304 may be the single communication device 208 responsible for communicating with all other communication devices 208, sending invitations to communication devices 208, processing requests to join the social network 204, and any other administrative function related to the social network 204.

In accordance with at least one embodiment of the present invention the network facilitator 304 may also be a communication device 208 that subscribes to the social network 204. In an alternative embodiment, the network facilitator 304 may be a device dedicated to facilitating the social network 204 and may not necessarily be associated with a user. For example, a stand-alone network facilitator 304 may comprise the only listing of members in an internal table and that device may facilitate subscriber 208 compliance with behaviors of social network 204. In accordance with at least one embodiment of the present invention, the network facilitator 304 may correspond to a wireless communication device with a predefined behavior or set of behaviors stored thereon associated with one or more social networks 204; the facilitator 304 manages such social networks 204 by soliciting/accepting subscribers to the social network 204, enforcing the behavior associated with that social network 204, and communicating with subscribing communication devices 208 of each social network 204. As can be appreciated, a single network facilitator 304 may manage one, two, three, or more social networks 204, each of which have a different set of subscribing communication devices 208 and/or behaviors associated therewith.

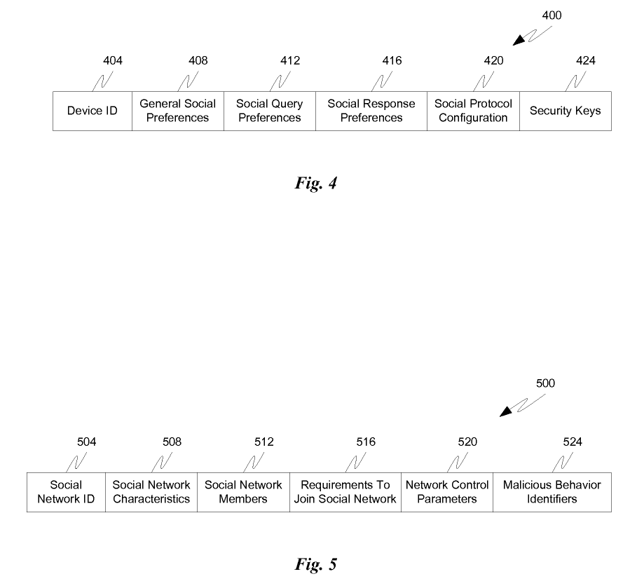

With reference now to FIG. 4, an exemplary data structure 400 used in connection with managing a social network 204 will be described in accordance with at least some embodiments of the present invention. The data structure 400 may be utilized by any subscribing communication device 208 or candidate communication device (i.e., a communication device 108 seeking to join or capable of joining a social network 204). The data structure 400 may include a number of fields related to the communication device 108, 208, the user of the communication device 108, 208, and preferences of the user of the communication device 108, 208. By way of example and not limitation, the data structure 400 may include a device identification field 404, a general social preferences field 408, a social query preferences field 412, a social response preferences field 416, a social protocol configuration field 420, and a security keys field 424.

The device identification field 404 may include information that is used to identify the communication device 108 maintaining the data structure 400 to another communication device, such as a subscribing communication device 208 or a network facilitator 304. This information may identify the device, the holder of the device, how to contact the device (e.g., an address or phone number associated with the device), or combinations thereof.

The general social preferences field 408 may contain general information related to the user's (i.e., a user of the communication device 108) preferences for social network preferences. This may include any type of predefined preference such as “do not join a social network that disengages X” or “search for social network that controls application/function/component Y” or the like. Other examples of general social preferences will become readily apparent after reading this disclosure. The general social preferences 408 may be provisioned prior to searching for or being invited to join a social network 204 or may be provisioned in response to receiving an invitation or based on search criteria.

The social query preferences field 412 may comprise information used by the communication device 108 to generate queries or search for particular social networks 204 having a certain behavior or set of behaviors associated therewith. The social query preferences field 412 may also define automated search queries that are allowable for the communication device 108. For example, the social queries preferences field 412 may comprise information defining the structure and possibly protocol of queries that can be sent to other communication devices to determine if they are a part or know of a social network 204.

The social response preferences field 416 may comprise information defining how the communication device 108 should respond to invitations to join a social network 204. For instance, the social response preferences field 416 may define that user input is required before responding to an invitation to join a social network 204. Alternatively, the social response preferences field 416 may define that an automated response to an invitation is allowable, possibly subject to certain criteria. For example, the social response preferences field 416 may provide that an automated response to an invitation is acceptable in the event that the behavior(s) of the social network 204 do not relate to a particular application, function, and/or component or, alternatively, in the event that the behavior(s) of the social network 204 do relate to a particular application, function, and/or component.

The social protocol configuration field 420 is used to store behavior information for social networks 204 to which the communication device belongs. More specifically, this field 420 is used by the communication device 108 when it subscribes to a social network 204 to maintain the behaviors that should be followed as long as the communication device 108 is a member of the social network 204. Therefore, data in the social protocol configuration field 420 controls the behavior of the communication device 108 by identifying which application(s), function(s), and/or component(s) should be engaged or disengaged while the communication device 108 is a part of the social network 204.

The security keys field 424 may store one or more security keys used to prove that the communication device 108 is a trusted communication device and to authenticate any other device that invites the communication device 108 to join a social network 204. As an example, the communication device 108 may store private keys from a public-private key set, public keys from a public-private key set, or private keys from a private-private key set, depending upon the authentication protocols that are employed by the communication device 108, specifically to join and analyze requests to join a social network 204.

With reference now to FIG. 5, another exemplary data structure 500 used in accordance with at least some embodiments of the present invention will be described. The data structure 500 may correspond to a member list or similar type of data structure used to manage the membership to a social network 204. To this extent, the data structure 500 may be maintained on any subscribing communication device 208 and/or on a network facilitator 304. The data structure 500 may include one or more fields to help in the management of the social network 204. Examples of such fields include, without limitation, a social network identifier field 504, a social network characteristics field 508, a social network members field 512, a requirements to join field 516, a control parameter field 520, and a malicious behavior identification field 524.

The social network identifier field 504 may comprise any identification information used to uniquely identify or refer to the social network 204. Such identification information may be in the form of a social network 204 name, a social network 204 number, a network facilitator 304 identifier, and/or a communication protocol used by the social network 204.

The social network characteristics field 508 may be used to store behavior information for the social network 204. More specifically, the behaviors required of subscribing communication device 208 may be maintained in the social network characteristics field 508.

The social network members field 512 may contain a listing of communication devices 208 subscribing to the social network 204. Subscribing communication devices 208 may be listed according to their device identifier, an address, a name of the user, or combinations thereof.

The requirements to join field 516 may comprise information that is referred to when determining whether a communication device 108 requesting to join a social network 204 is allowed to join the network 204. More particularly, information relating to required communication device applications, features, and/or components may be listed in the requirements to join field 516. Thus, if the social network behavior mandates engagement of a particular application, function, or component, then the requirements to join field 516 may indicate that communication devices 108 wanting to join the social network 204 be equipped with that particular application, function, or component.

The network control parameters field 520 may store information related to control protocols for the social network 204. More specifically, information related to protocols for requesting to join and sending invitations to social networks 204 are defined in the control parameters field 520.

The malicious behavior identifier field 524 may store information used to identify whether subscribing communication devices 208 are attempting to maliciously use or interfere with the social network 204. If any malicious behavior identified in this field is observed of a communication device 208, then that communication device 208 may be de-enrolled or otherwise restricted from participating in the social network 204. In accordance with at least one embodiment of the present invention, a de-enrolled communication device 208 may still be allowed to join a social network 204 but may be restricted from influencing the behavior of other devices. This is particularly relevant to an ad-hoc mode as opposed to a centrally controlled mode that centrally controls the operation of all members to the network 204.

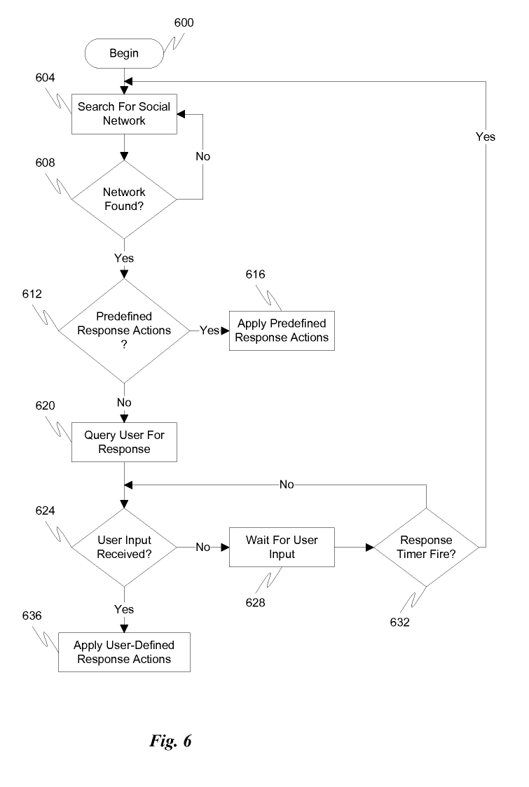

With reference now to FIG. 6, an exemplary social network discovery method will be described in accordance with at least some embodiments of the present invention. The method begins in step 600 and continues with a communication device 108 searching for a social network 204 (step 604). The searching step 604 may comprise the communication device 108 sending pings or search requests within its wireless communication range. Alternatively, this step may comprise opening the communication device 108 up for receiving invitations to join a social network 204. Accordingly, the searching step may be either a passive searching step whereby the communication device 108 waits for invitations or an active searching step whereby the communication device 108 sends messages inquiring about the existence of social networks.

Thereafter, the method continues by determining whether a social network 204 has been found (step 608). If no social network 204 is found, then the method returns to step 604. If, however, a social network 204 is found, then the method continues by determining whether the user has any predefined response actions for searching for or responding to the fact that a social network 204 has been found (step 612). Examples of such predefined response actions may include automatically asking to join the social network 204 or automatically inquiring as to the behaviors associated with the social network 204. If predefined response actions are defined, then the communication device 108 executes such actions automatically and in accordance with the user's predefined limitations (step 616). If, however, at step 612 no predefined response actions are defined, then the method continues by querying the user for instructions on how to respond to the fact that a social network 204 has been found (step 620).

The method waits until user input is received and then proceeds by executing response actions in accordance with the received user input (step 636). If, however, at step 624 no user input is received, then the method continues by waiting for user input (step 628) and determining whether a response timer has fired (step 632). If the response timer has fired (i.e., the user has waited too long to respond to the query), then it is assumed that the user does not want to join the social network 204, and the method returns to step 604. On the other hand, if the response timer has not fired, then the method returns to step 624. Upon application of the action(s), the user is then allowed to join the social network 204.

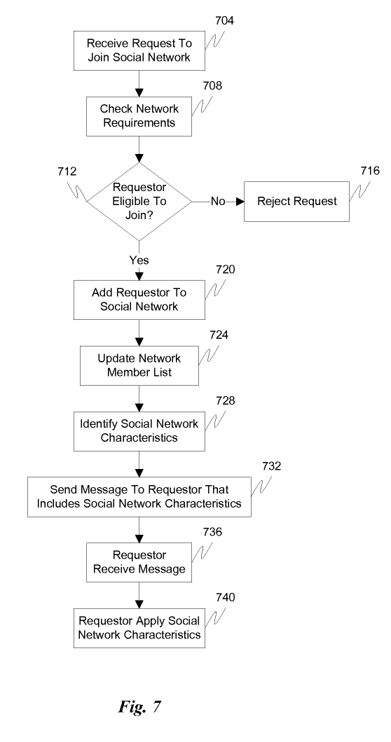

With reference now to FIG. 7, an exemplary social network admission method will be described in accordance with at least some embodiments of the present invention. The method is initiated when a subscribing communication device 208 and/or network facilitator 304 receives a request from another communication device 108 to join a social network 204 (step 704). Alternatively, this request may be received at a non-subscribing communication device 108 from a subscribing communication device 208 and/or network facilitator 304 (i.e., subscribing member) asking the non-subscribing communication device 108 (i.e., non-subscribing member) to join the social network 204.

In response to receiving the request, the recipient of the request checks the network requirements (step 708) to determine whether the other device is eligible to join the social network 204 (step 712). The recipient may also check the identity of the requester to determine if they are within a particular subscriber database. If the recipient is a subscribing member and the transmitter of the request is a non-subscribing member, then the recipient may check security keys received in the message to determine whether the communication device 108 can be authenticated as well as applications/functions/components supported by the communication device 108 to determine whether the communication device 108 is capable of complying with the social network 204 behaviors. On the other hand, if the recipient is a non-subscribing member and the transmitted of the request is a subscribing member, then the recipient may check the behaviors of the social network 204 to determine if the communication device 108 wants to and/or is capable of complying with the behaviors of the social network 204.

If the recipient is not eligible to join the social network 204 (e.g., because the recipient is not identified in a subscriber database), then the recipient rejects the request (step 716). A non-eligible recipient may correspond to a user that previously improperly used a social network and has been added to either a personal or global black list.

If, however, the recipient is eligible and the non-subscribing member wants to join the social network 204, then the method continues by adding the previously non-subscribing member to the social network 204 (step 720). The network member list is then updated with the identification information for the newly added member (step 724). The list may be updated at a single communication device 208 in the social network 204 or at several communication devices 208 in the social network 204.

After the member list has been updated, the social network characteristics, such as required behaviors and instructions for communicating within the social network 204 are identified (step 728) and included in a message that is sent to the requestor (step 732). As can be appreciated, these particular step(s) may have already been performed if the social behaviors were included in a request from a subscribing member to a non-subscribing member.

Regardless of when the behaviors are received at the newly added member (step 736), once the newly added member receives a message with the social behaviors required of subscribers to the social network 204 and agrees to join the social network 204 and comply with such behaviors, the newly added member stores those social network characteristics in memory and begins applying the behaviors associated with that social network 204 (step 740). The subscribing communication device 208 may continue to exhibit these behaviors as long as the communication device 208 wants to remain a part of the social network 204.

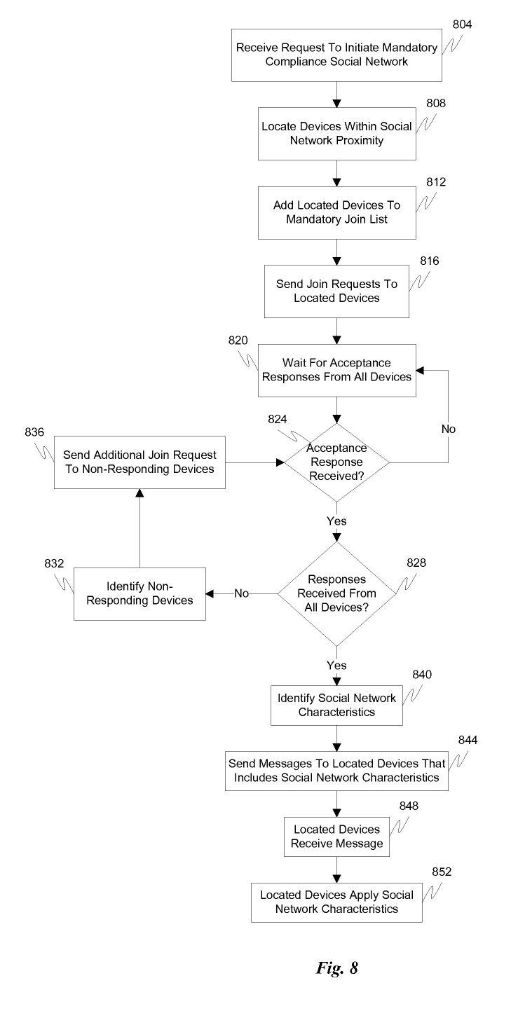

With reference now to FIG. 8, an exemplary method of facilitating a mandatory compliance social network will be described in accordance with at least some embodiments of the present invention. The method begins when a request is received at a communication device 208 and/or network facilitator 304 to initiate a mandatory compliance social network (step 804). This request may be received from a user or collection of users that have the desire to administer a mandatory compliance social network for a predetermined amount of time with a certain number of communication devices 108. This is particularly useful in meetings situations where all attendees to the meeting need to pay attention to the meeting and not email or IM. Similarly, this particular feature may be useful in classrooms or lectures where the speaker would like to ensure their audience is paying attention.

After the request is received, communication devices within social network proximity to the recipient of the original request are located (step 808). The social network proximity may correspond to the physical wireless communication limits of the network facilitator 304 or may correspond to any communication device within communication range of the network facilitator 304. Such devices may be known a priori (e.g., they are communication devices on an attendee list to a meeting) or may be discovered through a search and find protocol.

The located devices are added to a mandatory join list (step 812) and have join requests transmitted thereto from the network facilitator 304 (step 816). The method continues by waiting until an acceptance response is received from every communication device on the mandatory join list (steps 820 and 824). The method may stay in the loop for a predetermined amount of time until a timer fires that ends the loop and continues the method by removing any non-responding communication device from the mandatory join list. This prevents the method from getting caught in an infinite loop in the event that one or more communication devices fails to provide an acceptance response.

If no acceptance response is received, then the method continues to wait in the loop of steps 820 and 824, at least as long until the timer fires causing the loop to end. Once an acceptance response is received or the timer fires thereby causing a re-population of the mandatory join list, the method continues by determining whether acceptance responses have been received from all devices on the mandatory join list (step 828). If this query is answered negatively, then the network facilitator 304 identifies the non-responding devices (step 832) and sends them an additional join request (step 836). The method then returns to step 824. If, however, the timer has fired, then the mandatory join list is revised and the method is allowed to continue to a new step.

Once acceptance responses have been received from all devices on the mandatory join list either by response or by manipulation of the mandatory join list, the method continues with the network facilitator 304 identifying the social network characteristics associated with that social network 204 (step 840) and including such information in a message sent to all devices which are to be added to the social network 204 (step 844). These communication devices 108 receive the message containing the social network characteristics and store such information in their memory (step 848). Once received, each communication device 108, now a subscribing communication device 208, applies the social network characteristics including the behaviors defined therein and associated with the social network 204 (step 852). This causes all subscribing communication devices 208 on the mandatory join list to share behaviors and act in accordance with the desires of the network facilitator 304, which likely had behaviors defined therein by a meeting organizer, lecturer, or speaker.

While the above-described flowchart has been discussed in relation to a particular sequence of events, it should be appreciated that changes to this sequence can occur without materially effecting the operation of the invention. Additionally, the exact sequence of events need not occur as set forth in the exemplary embodiments. The exemplary techniques illustrated herein are not limited to the specifically illustrated embodiments but can also be utilized with the other exemplary embodiments and each described feature is individually and separately claimable.

The systems, methods and protocols of this invention can be implemented on a special purpose computer in addition to or in place of the described communication equipment, a programmed microprocessor or microcontroller and peripheral integrated circuit element(s), an ASIC or other integrated circuit, a digital signal processor, a hard-wired electronic or logic circuit such as discrete element circuit, a programmable logic device such as PLD, PLA, FPGA, PAL, a communications device, such as a phone, any comparable means, or the like. In general, any device capable of implementing a state machine that is in turn capable of implementing the methodology illustrated herein can be used to implement the various communication methods, protocols and techniques according to this invention.

Furthermore, the disclosed methods may be readily implemented in software using object or object-oriented software development environments that provide portable source code that can be used on a variety of computer or workstation platforms. Alternatively, the disclosed system may be implemented partially or fully in hardware using standard logic circuits or VLSI design. Whether software or hardware is used to implement the systems in accordance with this invention is dependent on the speed and/or efficiency requirements of the system, the particular function, and the particular software or hardware systems or microprocessor or microcomputer systems being utilized. The communication systems, methods and protocols illustrated herein can be readily implemented in hardware and/or software using any known or later developed systems or structures, devices and/or software by those of ordinary skill in the applicable art from the functional description provided herein and with a general basic knowledge of the computer and communication arts.

Moreover, the disclosed methods may be readily implemented in software that can be stored on a storage medium, executed on a programmed general-purpose computer with the cooperation of a controller and memory, a special purpose computer, a microprocessor, or the like. In these instances, the systems and methods of this invention can be implemented as program embedded on personal computer such as an applet, JAVA® or CGI script, as a resource residing on a server or computer workstation, as a routine embedded in a dedicated communication system or system component, or the like. The system can also be implemented by physically incorporating the system and/or method into a software and/or hardware system, such as the hardware and software systems of a communications device or system.

It is therefore apparent that there has been provided, in accordance with the present invention, systems, apparatuses and methods for allowing communications enabled devices to socialize with one another and establish a shared functionality. While this invention has been described in conjunction with a number of embodiments, it is evident that many alternatives, modifications and variations would be or are apparent to those of ordinary skill in the applicable arts. Accordingly, it is intended to embrace all such alternatives, modifications, equivalents and variations that are within the spirit and scope of this invention.

What is claimed is:

1. A method, comprising:
receiving, at a communication device, an invitation to join a social network comprising a communication device behavior associated therewith;
receiving an indication to accept the invitation to subscribe to the social network; and
altering a behavior of the communication device from a first default behavior to a second behavior, wherein the second behavior complies with the communication device behavior associated with the social network.

2. The method of claim 1, wherein the second behavior deactivates at least one of a function, application, and component of the communication device that is active in the first default behavior.

3. The method of claim 1, wherein the second behavior activates at least one of a function, application, and component of the communication device that is inactive in the first default behavior.

4. The method of claim 1, further comprising:
leaving, by the communication device, a range of the social network;
un-subscribing the communication device from the social network; and
resuming, by the communication device, the first default behavior.

5. The method of claim 1, further comprising:
receiving a request from the communication device to join the social network;
determining that the communication device is eligible to join the social network;
adding the communication device to a member list for the social network;
preparing a message for the communication device that includes a definition of the behavior associated with the social network; and
transmitting the message to the communication device.

6. The method of claim 5, further comprising:
receiving, by the communication device, the message;
analyzing the message to determine the behavior associated with the social network; and
thereafter, performing the altering step.

7. The method of claim 5, wherein the social network comprises a mandatory compliance social network, the method further comprising:
identifying all communication devices within a range of the social network;
ensuring that requests to join the social network are received from each identified communication device;
generating a message for each identified communication device, wherein each message includes a definition of the behavior associated with the social network; and
transmitting the message to its respective communication device, wherein each identified communication device applies the behavior associated with the social network during operation.

8. The method of claim 1, wherein the invitation is received from a communication device subscribing to the social network.

9. The method of claim 1, wherein the invitation is received from a social network facilitator.

10. A computer readable storage medium comprising processor executable instruction operable to perform the method of claim 1.

11. A method, comprising:
receiving a request from a communication device to join a social network;
determining that the communication device is eligible to join the social network;
preparing a message for the communication device that includes a definition of behavior associated with the social network; and
transmitting the message to the communication device.

12. The method of claim 11, wherein upon receiving the message, the communication device alters its behavior from a first default behavior to a second behavior, wherein the second behavior complies with the behavior associated with the social network.

13. The method of claim 11, wherein the social network comprises a mandatory compliance social network, the method further comprising:
identifying all communication devices within a range of the social network;
ensuring that requests to join the social network are received from each identified communication device;
generating a message for each identified communication device, wherein each message includes a definition of the behavior associated with the social network; and
transmitting the message to its respective communication device, wherein each identified communication device applies the behavior associated with the social network during operation.

14. The method of claim 11, wherein the request comprises security key and wherein determining that the communication device is eligible to join the social network comprises:
extracting the security key from the request; and
determining that the security key is a valid security key and provides permissions to join the social network.

15. The method of claim 11, further comprising adding the communication device to a member list for the social network.

16. The method of claim 11, wherein the second behavior deactivates at least one of a function, application, and component of the communication device that is active in the first default behavior.

17. The method of claim 11, wherein the second behavior activates at least one of a function, application, and component of the communication device that is inactive in the first default behavior.

18. The method of claim 11, further comprising:
receiving, at the communication device, an invitation to join the social network;
receiving an indication to accept the invitation to subscribe to the social network;
in response to receiving the indication to accept the invitation, generating the request to join the social network; and
sending the request to at least one of an existing subscriber to the social network and a social network facilitator.

19. A communication device, comprising:
a communication interface operable to receiving an invitation to join a social network comprising a communication device behavior associated therewith;
a user input operable to receive an indication to accept the invitation to subscribe to the social network; and
a processor operable to alter a behavior of the communication device from a first default behavior to a second behavior, wherein the second behavior complies with the communication device behavior associated with the social network.

20. The device of claim 19, further comprising:
at least one of a function, application, and component that is active while operating in the first behavior but inactive while operating in the second behavior.

21. The device of claim 20, wherein the at least one of a function, application, and component is a component and wherein the component is a speaker that is adapted to generate audible tones in the first behavior but rendered inactive in the second behavior.

22. The device of claim 20, wherein the at least one of a function, application, and component is an application and wherein the application is a communication application that is adapted to allow a user to connect with other communication devices and conduct communication sessions with such devices in the first behavior but locked in the second behavior.

23. The device of claim 19, further comprising:
at least one of a function, application, and component that is inactive while operating in the first behavior but active while operating in the second behavior.

24. The device of claim 19, wherein the invitation is received from a communication device subscribing to the social network.
